(19) United States
(12) Patent Application Publication
(10) Pub. No.: US 2022/0004996 A1
(43) Pub. Date: Jan. 6, 2022

(54) Temporary Employment Assistance System

(71) Applicant: Megan Hayward, Jacksonville, FL (US)

(72) Inventor: Megan Hayward, Jacksonville, FL (US)

(21) Appl. No.: 17/368,788

(22) Filed: Jul. 6, 2021

Related U.S. Application Data
(60) Provisional application No. 63/048,022, filed on Jul. 3, 2020.

(51) Int. Cl. G06Q 10/10; G06Q 10/06; G06F 21/31

(52) U.S. Cl. CPC G06Q 10/1053; G06F 21/31; G06Q 10/063112

(57) ABSTRACT

The present invention presents a temporary employment assistance system that uniquely connects hiring parties and staffing parties with one another. The present invention provides an interactive map that graphically depicts the geographic location of each job order using methods that assist the hiring parties and staffing parties in budgeting and planning for each job order. The temporary employment assistance system enables the hiring party to initially establish the contractual terms and billing rates while also allowing the parties to efficiently negotiate the contractual terms and billing rates. The temporary employment assistance system provides a company profile for each party. The company profile includes one or more ratings based on feedback provided by other parties. The temporary employment assistance system also provides an automated confirmation process at a predetermined time prior to the start of an event to ensure the event is adequately and accurately staffed. The temporary employment assistance system further comprises a unique timesheet authentication process for workers.

### CROSS-REFERENCE TO RELATED APPLICATIONS

This application claims priority of U.S. patent application Ser. No. 63/048,022, filed on Jul. 3, 2020.

### BACKGROUND OF THE INVENTION

### A. Field of the Invention

This invention relates to a temporary employment assistance system for connecting hiring companies with one or more staffing agencies.

### B. Prior Art

The current process for hiring temporary employees or contractors, hereinafter referred to as “workers”, presents a budgeting dilemma for hiring companies when a job requires many workers; and, therefore, requires contracting with several staffing agencies. Often hiring companies, hereinafter referred to as “hiring parties”, are faced with time-sensitive logistical constraints that relate to last-minute cancellations as well as no-shows. Hiring parties are often tasked with managing risks associated with fluctuations in worker turnout. Some hiring parties hedge this risk by requesting extra workers. However, hiring extra workers results in potentially excessive labor costs. Similarly, staffing agencies, hereinafter referred to as “staffing parties”, sometimes try to hedge their fulfillment obligations by sending more workers to a job than the hiring party's respective labor costs.

Additionally, each staffing party often dictates its own billing rate and contract provisions within the terms of its service agreement. Consequently, the hiring party faces additional budgetary increases to accommodate transactional inefficiencies pertaining to the varying billing rates and contractual provisions for each staffing party for each job.

The prior art teaches of employment management systems that attempt to solve the budgeting dilemma by connecting hiring parties directly with workers. However, the additional risk and overhead involved with directly contracting workers can be problematic for some hiring parties. Some hiring parties are not able to manage the process of finding workers directly.

The budgeting dilemma for the hiring party is significantly magnified when the hiring party has multiple jobs requiring large numbers of workers periodically throughout a year. As such, a solution to this budgeting dilemma is greatly needed.

### BRIEF SUMMARY OF THE INVENTION

The present invention relates to a temporary employment assistance system that improves efficiency of coordination between hiring parties and staffing parties. The temporary employment assistance system enables hiring parties and staffing parties to precisely and accurately identify the number of workers needed for a job, efficiently coordinate contractual provisions as it relates to the job, and maintain consistent communication with each other as it relates to matters in connection with the job.

Accordingly, the temporary employment assistance system will comprise a network application that streamlines the contracting process by utilizing pre-determined terms and billing rates, allows a hiring party to create a job order with one or more requested positions, allows one or more staffing parties to claim one or more of the one or more requested positions for the job order, and provides a variety of collaboration tools. The variety of collaboration tools includes a mapping feature, which allows hiring parties and staffing parties, hereinafter collectively referred to as the “parties”, to each view and filter job orders using an interactive map which displays the geographic location of each job. Furthermore, the temporary employment assistance system provides the hiring party the opportunity to quickly engage one or more staffing parties for one or more of its respective job orders.

In addition, the temporary employment assistance system provides a solution for increasing the accuracy of billable hours recorded by each worker assigned to a job. A foreman, provided by the hiring party, often is required to document the time each worker arrives to the job site. The foreman may document the time each worker arrives by either using a timesheet, which can be uploaded to the temporary employment assistance system at a later time; or, alternatively, use a mobile device that has an integrated camera and is linked to the temporary employment assistance system to scan or photograph a worker ID provided by the worker, which may comprise an identification card, as a means to document the arrival of the worker. Similarly, prior to the worker leaving the job site, the foreman may document the worker's departure with either the timesheet, or by using the mobile device to scan or photograph the worker ID.

### BRIEF DESCRIPTION OF THE DRAWINGS

FIG. 1 depicts a schematic diagram of an exemplary embodiment of a temporary employment system.

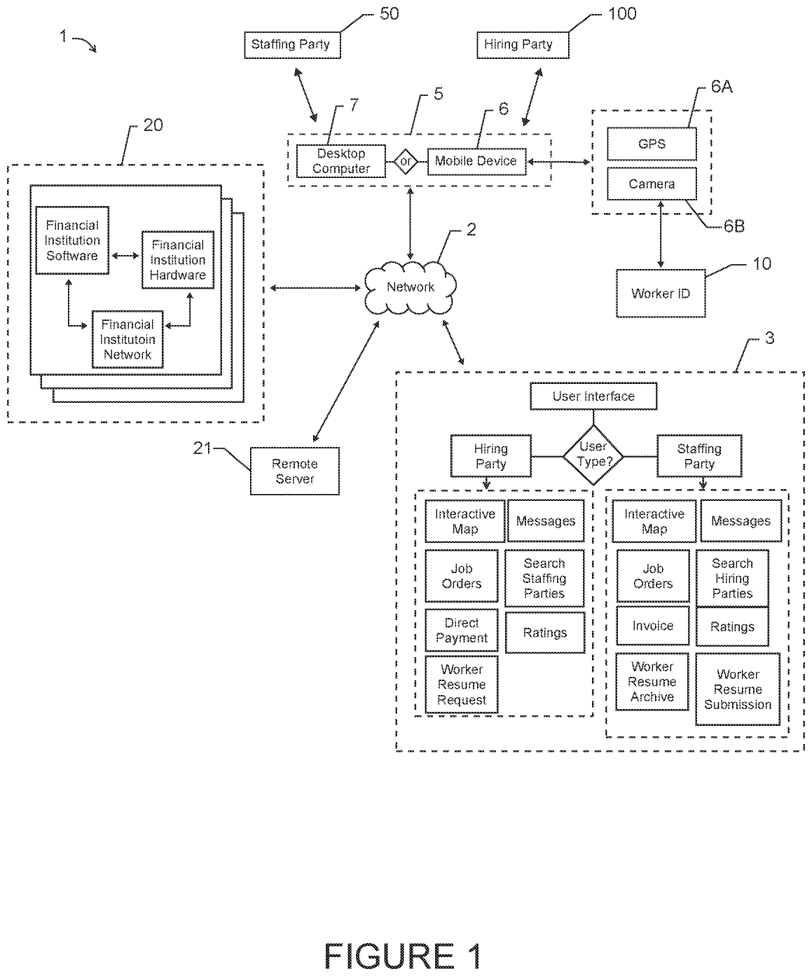

FIG. 2 depicts a schematic diagram that shows how a hiring party or a staffing party may access its respective user account within the temporary employment assistance system.

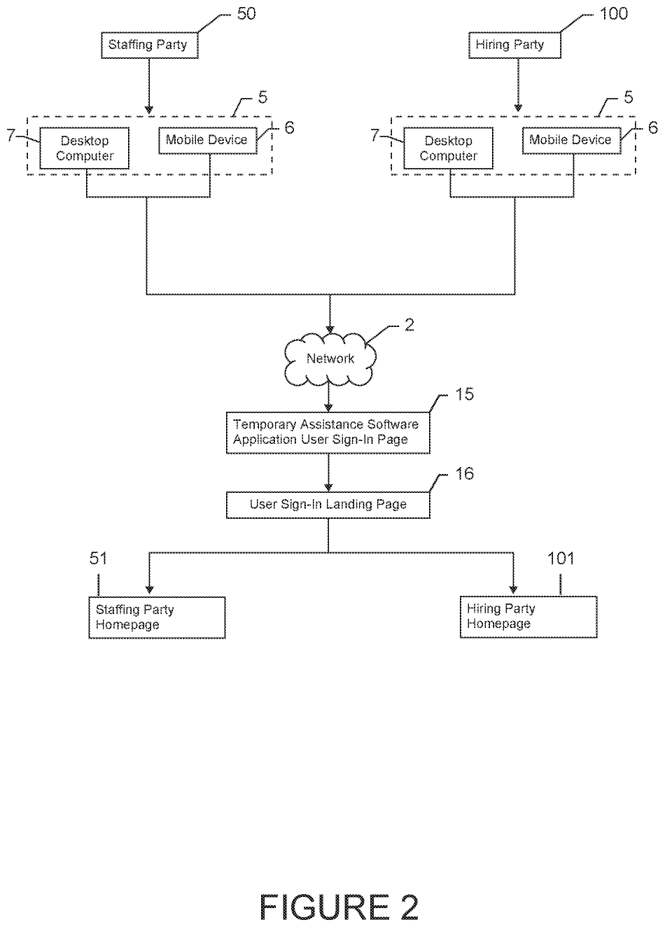

FIG. 3 depicts a schematic diagram that shows how the staffing party can interface with the temporary employment assistance system after the staffing party has logged into its respective user account.

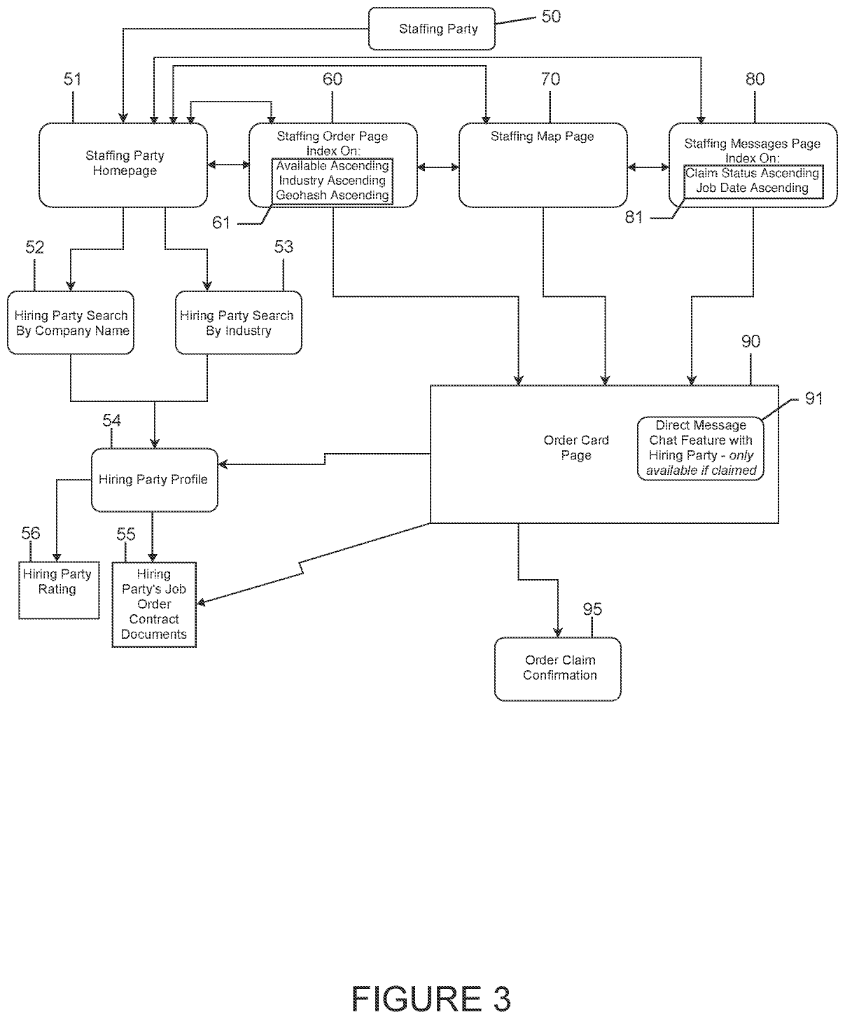

FIG. 4 depicts a schematic diagram that shows how the staffing party can interface with an interactive map that visually displays one or more jobs.

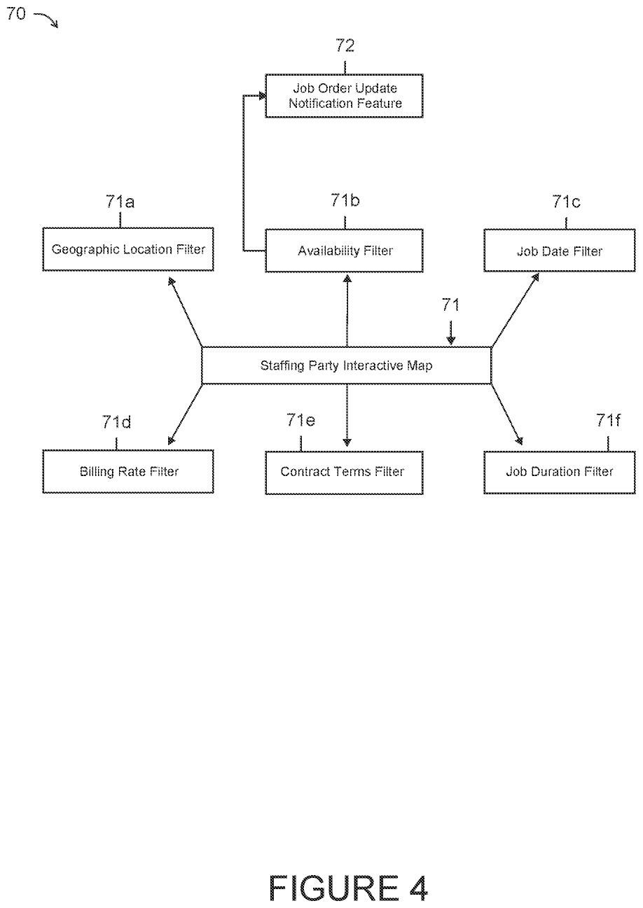

FIG. 5 depicts a schematic diagram that shows how the hiring party can interface with the temporary employment assistance system after the hiring party has logged into its respective user account.

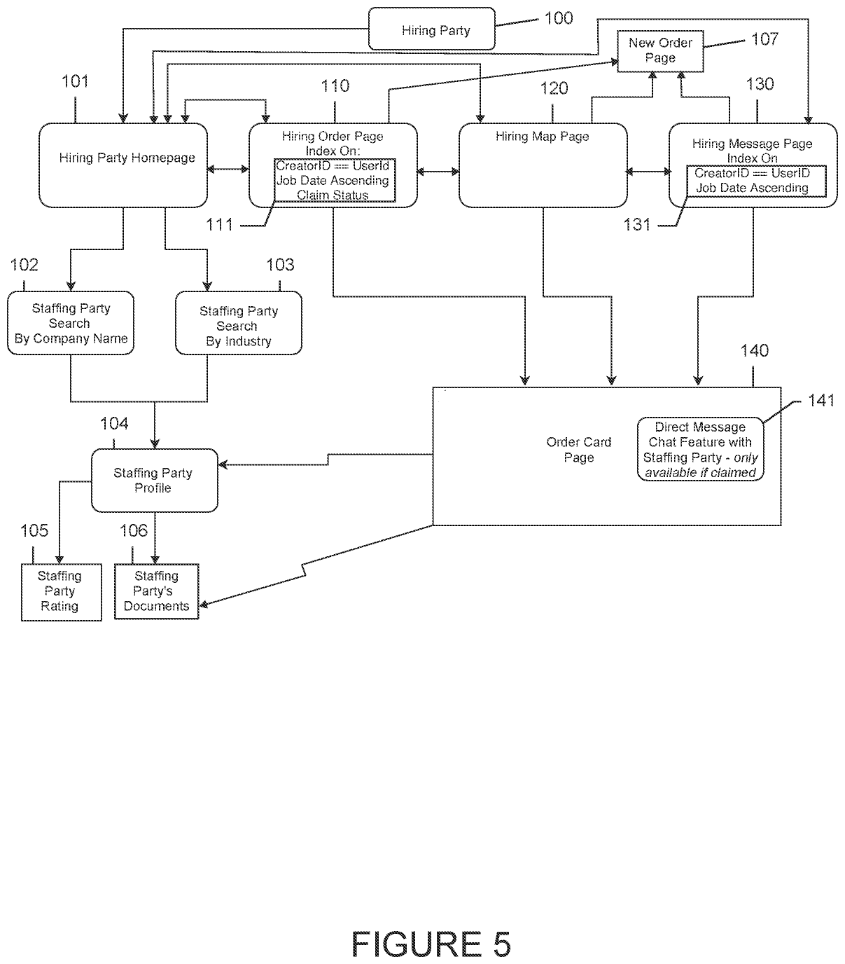

FIG. 6 depicts a schematic diagram that shows how the hiring party can interface with an interactive map that visually displays one or more jobs.

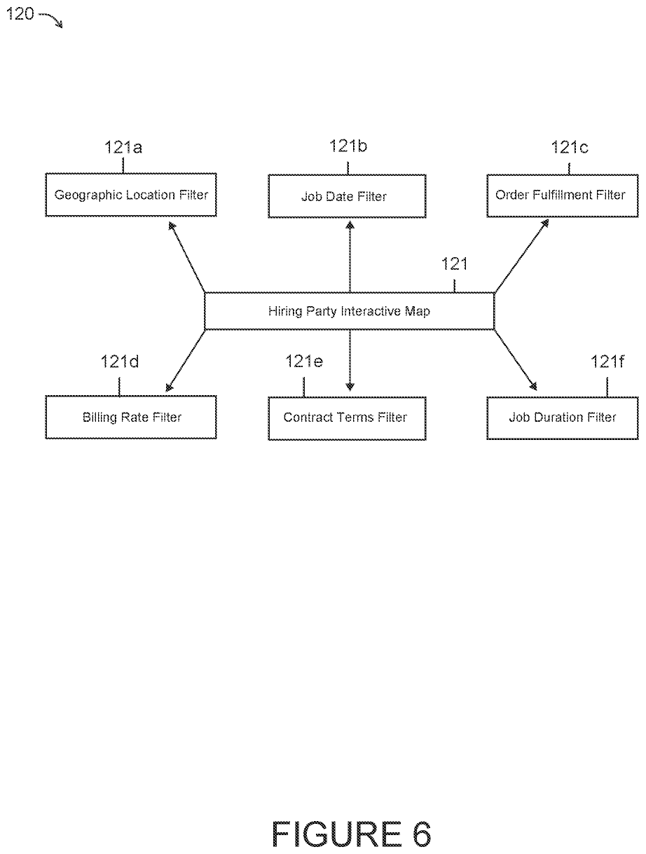

### NUMBERING REFERENCE

1—Temporary employment assistance system
2—Network
3—Software application
5—Personal computing device
6—Mobile device
6A—GPS
6B—Camera
7—Desktop computer
10—Worker ID
20—One or more financial institutions
21—Server
15—User account sign-in page
16—Sign-in landing page
50—Staffing party
51—Staffing party homepage
52—Hiring party search by company name filter
53—Hiring party search by industry filter
54—Hiring party profile
55—Hiring party's job order contract documents
56—Hiring party rating
60—Staffing order page
61—Variety of order index filters
70—Staffing party map page
71—Staffing party interactive map
71a—Geographic location filter
71b—Availability filter
71c—Job date filter
71d—Billing rate filter
71e—Contract terms filter
71f—Job duration filter
72—Job order update notification feature
80—Staffing party messages page
81—Variety of staffing message filters
90 —Staffing order card page
91—Direct message to hiring party
95—Order claim confirmation page
100—Hiring party
101—Hiring party homepage
102—Staffing party search by company name filter
103—Staffing party search by industry filter
104—Staffing party profile
105—Staffing party rating
106—Staffing party's documents
107—New order page
110—Hiring order page
111—Variety of hiring order index filters
120—Hiring party map page
121—Hiring party interactive map
121b—Job date filter
121c—Fulfillment filter
121d—Billing rate filter
121e—Contract terms filter
121f—Job duration filter
130—Hiring messages page
131—Variety of hiring message filters
140—Hiring order card page
141—Direct message to staffing party

### DETAILED DESCRIPTION OF THE EMBODIMENTS

A non-limiting exemplary embodiment of a temporary employment assistance system 1 uniquely connects hiring parties 100 with staffing parties 50. Often the parties 50, 100 are negatively impacted by inefficient processes that increase the time and cost of doing business. The temporary employment assistance system 1 provides a platform for improving the efficiency of coordination between the parties 50, 100.

Because large events often require hiring large numbers of workers, a single staffing party 50 may be incapable of providing the total number of workers being requested by the hiring party 100. In such cases, a hiring party 100 must engage in contracting multiple staffing parties 50. In order to optimize the transactional process between the hiring party 100 and each individual staffing party 50, the temporary employment assistance system 1 streamlines coordination between the parties 50, 100 such that each of the parties 50, 100 may efficiently manage their respective operations and effectively coordinate in real-time.

The temporary employment assistance system 1 comprises one or more staffing parties 50, one or more hiring parties 100, a network 2, a software application 3, and a remote server 21. The software application 3 provides a virtual marketplace for hiring parties 100 and staffing parties 50 to collaborate on one or more job orders corresponding to one or more jobs which require one or more workers. The software application 3 can be accessed by the parties 50, 100 using a personal computing device 5 capable of connecting to the network 2, such as a mobile device 6 or a desktop computer 7, and is capable of connecting to one or more financial institutions 20. The mobile device 6 provides an integrated GPS 6A and camera 6B. It is anticipated that the GPS 6A corresponding to a worker's mobile device 6 may be accessed by the software application 3 and the location of the worker may be shared with the hiring party 100 during a predetermined time period before and during a job that the worker is contracted to work.

To access the software application 3, each party 50, 100 must initially create a user account within the temporary employment assistance system 1. Each party 50, 100 creates a unique username and password that are henceforth used to access their respective user account via a user sign-in page 15. Upon logging in for the first time, the software application 3 provides a sign-in landing page 16 that prompts the user to indicate whether it is a staffing party 50 or a hiring party 100. If the user indicates that it is a hiring party 100, it is subsequently taken to a hiring party homepage 101. Similarly, if the user indicates that it is a staffing party 50, it is subsequently taken to a staffing party homepage 51. Following the initial sign-in, the user is taken to its respective homepage after signing in on the user sign-in page 15.

If the user is a staffing party 50, then the user will navigate a variety of collaboration tools that can be accessed via the staffing party homepage 51, a staffing order page 60, a staffing party map page 70, and a staffing message page 80. The staffing party homepage 51 provides several searching features that enable the staffing party 50 to directly search for hiring parties 100 that have accounts within the temporary employment assistance system 1. A staffing party 50 may search for a particular hiring party 100 by either using the hiring party search by company name filter 52 or by selecting a specific industry using the hiring party search by industry filter 53.

Staffing parties 50 often develop valuable relationships with hiring parties 100; and, accordingly, engage in repeat business with said hiring parties 100 they have previously worked with is preferable. Each search result provided by the filters 52, 53 provides a link to a hiring party profile 54 that provides an overview of the hiring party 100. The hiring party profile 54 includes the hiring party's job order contract documents 55, a hiring party rating 56 for one or more qualities; and, optionally, a credit score for the hiring party 100.

The staffing order page 60 indexes the job orders by using a variety of order index filters 61. If the staffing party 50 finds a job order that is of interest, the indexed job order provides several links that enable the staffing party 50 to acquire additional information about the job order. The staffing order page 60 links to the staffing order card page 90, which provides a detailed description of the job order. If one or more positions within the job order are claimed by the staffing party, the software application 3 generates an order claim confirmation 95 receipt for the staffing party 50. After the staffing party claims one or more positions for a job order, the software application automatically grants the staffing party 50 permission to send a message to the hiring party 100 via the direct message to hiring party 91 feature. Alternatively, the hiring party 100 may directly solicit a job order with an individual staffing party 50. A direct solicitation for a job order may remain private or be made public, if the solicited staffing party 50 is unable to claim the entire job order.

Additionally, after a staffing party 50 claims one or more positions for a job order, the staffing party 50 may upload an invoice corresponding to the claimed positions which it has filled. The uploaded invoice will attach to the job order. The hiring party 100 that created the job order will have access to the invoice and may remit payment through the software application 3.

The staffing party map page 70 provides a staffing party interactive map 71 that displays the locations of job orders created and published within the software application 3. The interactive map provides a variety of staffing party map filters that enable the staffing party 50 to filter job orders based on a set of varying parameters. It is of great value to be able to visually review the geographic location of job orders. Staffing parties 50 may use information garnered from the interactive map in a variety of ways to better evaluate which job orders they claim. Furthermore, retrospective insights regarding the success or shortcomings of a past job order are often improved by having the ability to efficiently map the past job order and visually compare each job order's respective geographic location with one another.

The variety of staffing party map filters includes a geographic location filter 71a, an availability filter 71b, a job date filter 71c, a billing rate filter 71d, a contract terms filter 71e, and a job duration filter 71f. Each filter of the variety of staffing party map filters enables the staffing party 50 to strategically utilize data corresponding to the geographic locations of job orders to optimize satisfaction of hiring parties 100 and workers, and thoughtfully place of workers. It is anticipated that by clicking the job location on the map, the hiring party profile 54 would become accessible, and viewable, wherein the respective contract terms and job duration information would be provided.

The geographic location filter 71a enables the staffing party 50 to create a geographic boundary when searching and reviewing job orders on the staffing party interactive map 71. The geographic boundary can either be traced manually by the staffing party 50 or established by first selecting a location and then indicating a maximum distance from the selected location to be used as the radius of the geographic boundary.

The availability filter 71b enables the staffing party 50 to more efficiently review current job orders based on the number of positions that have been claimed within the job order. The staffing party 50 is given several options to display job orders on the staffing party interactive map 71 based on the number of positions that have been claimed. It is anticipated that job orders are able to be differentially depicted on the staffing party interactive map 71 using a color-coded system.

Additionally, the software application 3 has a job order update notification feature 72 that visually flags job orders that the staffing party 50 previously claimed if the number of available positions for the respective job order have increased since the point in time when the staffing party 50 initially claimed the job order. The job order update notification feature 72 generates an automated message when one or more positions of a job order become available. The automated message is sent directed to each staffing party 50 that previously claimed one or more positions of the job. The job order update notification feature 72 efficiently updates one or more staffing parties 50 for each job order which the staffing party 50 has claimed one or more positions.

The date filter 71c enables the staffing party 50 to only view job orders on the staffing party interactive map 71 that are set to start on a particular date or particular range of dates that are of interest.

The billing rate filter 71d allows the staffing party 50 to filter job orders shown on the staffing party interactive map 71 based on a minimum billing rate. This can be beneficial for staffing parties 50 that only wish to claim job orders that meet or exceed their minimum billing rates.

The contractual terms filter 71e provides the staffing party 50 with the option to only display jobs that have been posted by hiring parties 100 that include particular contractual term requirements. Alternatively, it is also anticipated that the staffing party 50 may use the contractual terms filter 71e to flag any job orders that don't satisfy their specific contractual term requirements while also showing all of the other job orders that do satisfy their particular contractual term requirements.

The job duration filter 71f allows the staffing party 50 to depict job orders that are of a minimum duration. It can be desirable for numerous reasons for a staffing party 50 to seek out job orders that are multi-day events. As such, the job duration filter 71f enables staffing parties 50 to quickly locate job orders that meet a particular duration criterion established by the staffing party 50.

The staffing message page 80 provides the staffing party 50 with a log of direct messages to hiring parties 100 who have provided job orders that the staffing party 50 has claimed. A consolidated log of messages may be filtered by date, hiring party, or job order. Furthermore, automated notifications to staffing parties 50 are anticipated to be provided for a variety of scenarios. An example of an automated message that the staffing party 50 could receive might include a notification updating the staffing party 50 when the number of available open positions for a job order that the staffing party 50 previously claimed, but has not yet taken place, has increased since the time that the staffing party 50 originally claimed the job order. An additional example of an automated notification that the staffing party 50 is anticipated to receive, would include a reminder of an upcoming job order and request to confirm that the number of positions that the staffing party 50 previously claimed is still accurate and does not require modification.

A hiring party homepage 101 is provided by the temporary employment assistance system 1 for users who login and indicate that they are a hiring party 100. The hiring party homepage links to numerous components provided by the software system 1 including a hiring order page 110, the hiring party map page 120, and a hiring message page 130. The hiring party homepage 101 enables the hiring party 100 to directly search for staffing parties 50 by either searching for a particular staffing party 50 using the staffing party search by company name filter 102 or by selecting a specific industry by using the staffing party search by industry filter 103. Both filters 102, 103 will link to a staffing party profile 104 that provides an overview of the staffing party 50, which includes the staffing party's documents 106, comprise the staffing party's accounts billable information and contact information. The staffing party profile 104 also provides a staffing party rating 105.

The hiring order page 110 indexes the job orders created by the hiring party 100 using a variety of order index filters 111. Each job order within each index displays the total number of positions requested by the hiring party 100, as well as the number of positions claimed by one or more staffing parties 50. Each job order listed on the hiring order page 110 also provides a link to view the hiring order card page 140, a link to a summarized review of the job order, and a link to direct message each staffing party 50 who has claimed one or more positions for the job order.

The hiring order card page 140 provides a detailed description of each job order created by the hiring party 100. The hiring party 100 may elect to create a job order that is either openly advertised to all staffing parties 50 or alternatively create a direct job order for one or more specific staffing parties 50. The hiring party 100 may optionally require that the staffing party 50 submit resumes for workers which it intends to send out to the job. The hiring company 100, may, at its discretion, reject or accept workers on an individual basis based on its review of each worker's respective resume. The software application 3 provides and enables a direct message to the staffing party 141 feature for each job order that has one or more positions claimed by one or more staffing parties 50. The software application 3 also enables the hiring party 100 and staffing party 50 to establish a contractual agreement for future job orders to improve the efficiency and reliability of the contractual process. The billing rates and terms corresponding to the contractual agreement are negotiated and agreed to by the parties 50, 100 in advance. The contractual agreement is accessible to view by both parties 50, 100 within the software application 3. After the parties 50, 100 have established and mutually agreed to the terms of their mutual contractual agreement, the hiring party 100 is able to quickly engage the staffing party 50 by directly notifying the staffing party 50 about new job orders it creates within the software application 3. The staffing party 50 must execute the contractual agreement for each new job order, but since the billing rates and terms have been previously established, the process is significantly expedited.

The hiring party map page 120 provides a hiring party interactive map 121 that displays the locations of job orders created by the respective hiring party 100; and, accordingly, is unique to each hiring party 100. It is of significant value to visually display the geographic locations of the hiring party's 100 job orders. Mapping the geographic locations of the hiring party's 100 job orders enables the hiring party 100 to more aptly determine if the staffing party 50 is well suited for the job order by comparing a particular staffing party's 50 past jobs to see if there are any geographic correlations. Additionally, the hiring party interactive map 121, provided by the hiring party map page 120, also provides color coded markers that visually identify the fulfillment status of upcoming job orders to assist the hiring party 100 in planning and adjusting to staffing deficiencies when applicable.

The hiring party interactive map 121 provides a variety of hiring party map filters that enable the hiring party 100 to quickly review job orders based on a variety of parameters. The variety of hiring party map filters include a geographic location filter 121a, a job date filter 71b, a fulfillment filter 121c, a billing rate filter 121d, a contract terms filter 121e, and a job duration filter 121f. Each filter of the variety of hiring party map filters 121a, 121b, 121c, 121d, 121e, 121f enables the hiring party 100 to quickly correlate the geographic location of a job order with various parameters.

The hiring message page 130 provided by the temporary employment assistance system 1 provides the hiring party 100 with an archive of messages to staffing parties 50 that have claimed prior, current, or future job orders created by the hiring party 100.

The temporary employment assistance system 1 also provides a new order page 107 that enables hiring parties 100 to create a new job order. The new order page 107 provides a plurality of predetermined input fields that enable the hiring party 100 to describe the new job order efficiently and adequately. The temporary employment assistance system 1 will not allow the hiring party 100 to post the new job order unless all of the required input is provided. If the hiring party 100 wishes to engage a particular staffing party 50, the new order page 107 allows the hiring party to select whether the new job order is to be advertised openly (“publicly”) to all staffing parties 50 or as a direct job order solicitation for one or more select staffing parties 50.

In addition, the temporary employment assistance system 1 provides a solution for increasing the accuracy of billable hours recorded by each worker assigned to a job. A foreman, provided by the hiring party 100, is often required to document the time each worker arrives to a job site. In such cases, the foreman may document the time each worker arrives by either using a timesheet, which can be uploaded to the temporary employment assistance system at a later time; or, alternatively, use the camera 6B, provided by the mobile device 6, to scan or photograph a physical object provided by the worker, such as a worker ID 10, to verify the identity of the worker and authenticate the time the worker arrived to the job site. The worker ID 10 may comprise an identification card, an identification badge, an object, or a physical attribute, such as a fingerprint, that uniquely identifies the worker. Similarly, prior to the worker leaving the job site, the foreman may document the worker's departure time by recording the departure time on the timesheet or by using the camera 6B to scan or photograph the worker ID 10.

While the embodiments of the invention have been disclosed, certain modifications may be made by those skilled in the art to modify the invention without departing from the spirit of the invention.

What is claimed:

1. A temporary employment assistance system comprising:
a. one or more staffing parties;
b. one or more hiring parties;
c.a network;
d.a personal computing device;
wherein the personal computing device is capable of connecting to a network;
wherein the personal computing device may comprise a mobile device or a desktop computer;
wherein the mobile device comprises an integrated GPS and camera;
e.a software application;
wherein the software application is connected to the network;
wherein the software application comprises a plurality of user accounts;
wherein each of the one or more hiring parties and the one or more staffing parties has a user account;
wherein the one or more hiring parties may create one or more job orders;
wherein the software application further comprises a virtual market place;
wherein the virtual marketplace further comprises a hiring party interactive map and a staffing party interactive map;
wherein the hiring party interactive map provides a unique display of job orders to each hiring party by only displaying job orders created by the respective hiring party;
wherein the hiring party interactive map may filter the job orders it displays with a variety of hiring party map filters;
wherein the variety of hiring map filters comprises a job availability filter;
wherein the software application provides a job order update notification feature;
wherein the staffing party interactive map displays the geographic locations of all job orders created by the one or more hiring parties;
wherein the staffing party interactive map may filter the job orders it displays with a variety of staffing party map filters;
wherein each job order corresponds to a job and comprises a job description, a job location, a job date, one or more types of positions, and a specific number of positions for each type of position requested by the hiring party;
wherein the one or more staffing parties may claim one or more positions corresponding to the one or more job orders;
f.a remote server;
wherein the remote server is connected to the network;
g.a worker ID;
wherein the worker ID uniquely identifies a worker.

2. The temporary employment assistance system as described in claim 1, wherein the variety of staffing party map filters and variety of hiring party map filters comprise a geographic location filter, a job date filter, a fulfillment filter, a billing rate filter, a contract terms filter, and a job duration filter;

3. The temporary employment assistance system as described in claim 1, wherein the worker ID is scanned or photographed by the camera;

4. The temporary employment assistance system as described in claim 3, wherein the worker ID is used to authenticate the identity of the worker and the time the worker arrives and departs from a job site.
